(19) United States
(12) Patent Application Publication
(10) Pub. No.: US 2009/0063341 A1
(43) Pub. Date: Mar. 5, 2009

(54) Stored value card redeemable for cash

(76) Inventors: James O'Sullivan Clarke, III, Franklin, TN (US); Jeffrey Russell Ballard, Brentwood, TN (US); Robert George Miller, Smyrna, TN (US)

Correspondence Address: David M. Ostfeld;Adams and Reese, LLP, 4400 One Houston Center, 1221 McKinney Street, Houston, TX, 77010, US

(21) Appl. No.: 11/899,268

(22) Filed: Sep. 5, 2007

(51) Int. Cl. G06Q 40/00

(52) U.S. Cl. 705/41

(57) ABSTRACT

Disclosed are systems and methods for providing a stored value card that is redeemable for cash value or merchandise, and so suffices to provide consideration.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to a computerized method for processing financial data, wherein the method is designed to plan the disposition of funds, and comprises an object having a value-carrying memory, and a user operated arrangement for programming the value-carrying memory prior to use.

2. Description of Related Art

Stored value cards are cards with stored monetary values on them. They are typically given: 1) as a gift; 2) in exchange for a return of merchandise; or 3) in a loyalty program. Stored value cards can typically be used at the merchant that originally issued the gift card in exchange for goods and/or services. Some stored value cards can be reloaded with additional funds, but existing stored value cards cannot be redeemed for cash value. Because the stored value cards cannot be redeemed for cash value, redemption of existing stored value cards does not equate with giving of consideration.

In the magazine industry there is a need for a stored value card redeemable for cash value. The magazine industry and its auditing body, the Audit Bureau of Circulations (ABC), require the individual consumer to give consideration in exchange for a magazine subscription. If a stored value card is given to an individual consumer, a stored value card holder, the consumer may decide either to: 1) purchase a good and/or service from the merchant; or 2) not to make a purchase and, therefore, receive nothing of value. However, if the consumer gives consideration for a magazine subscription, the publisher may classify this circulation as individual paid circulation, which is the most desired circulation category among publishers.

### BRIEF SUMMARY OF THE INVENTION

An object of the invention is to overcome the above and other drawbacks in existing stored value card schemes.

Another object of the invention is to provide a method for issuing a stored value card comprising: presenting a purchaser with an opportunity to buy the stored value card, receiving funds for purchase of the stored value card, creating a stored value card account for the purchased stored value card, and issuing the stored value card.

A further object of the invention is to provide a stored value card wherein the stored value card holder may elect to redeem the stored value card for cash value.

A further object of the invention is to provide a stored value card wherein the stored value card holder may elect to redeem the stored value card optionally for either merchandise or for cash value.

A further object of the invention is to provide a stored value card wherein, upon electing to redeem the stored value card for cash value, the stored value card holder electronically notifies the stored value card issuer of the election to redeem the stored value card for cash value.

As used herein, “purchaser” means an individual or entity that provides funds, in any denomination having cash value, to pay for a stored value card according to the present invention.

As used herein, “stored value card data” or “redemption information” means a unique, random, alphanumeric code (“unique code”) that is generated at the time a stored value card is purchased and imprinted on the stored value card. This unique code, along with the value of the funds provided for purchase of the stored value card (the “purchased value”), is stored in a database (the “current stored value”). At the moment of purchase, the original purchased value and the current stored value associated with any stored value card (identified by its unique code) is equal. Upon redemption, whether for cash value or for merchandise, the stored value card holder is prompted to enter the unique code for the stored value card held. This unique code is verified in the database, and the current stored value of the card is retrieved (and optionally displayed). “Stored value card data” or “redemption information” may optionally include the first name, last name, postal address, city, state, zip code, and email address of a stored value card holder.

A further object of the invention is to provide a stored value card wherein, upon receiving notification of the stored value card holder's election to redeem the stored value card for cash value, the stored value card issuer prompts the stored value card holder for redemption information.

A further object of the invention is to provide a stored value card wherein, upon receiving redemption information, the stored value card issuer verifies the redemption information provided.

A further object of the invention is to provide a stored value card wherein, when verifying the redemption information: 1) if the redemption information is found invalid then the stored value card holder is notified that the redemption information was found invalid; or 2) if the redemption information is found valid, then the stored value card holder is notified that payment will be processed.

A further object of the invention is to provide a stored value card wherein, after notifying the stored value card holder that payment will be processed, the stored value card issuer provides payment to the stored value card holder.

A further object of the invention is to provide a stored value card wherein payment to the stored value card holder may be in the form of a check made payable to the stored value card holder.

A further object of the invention is to provide a stored value card wherein, upon electing to redeem the stored value card for merchandise and declining to redeem the stored value card for cash value, the stored value card holder electronically notifies the stored value card issuer of the election to redeem the stored value card for merchandise.

A further object of the invention is to provide a stored value card wherein, upon receiving notification of the stored value card holder's election to redeem the stored value card for merchandise, the stored value card issuer prompts the stored value card holder to select one or more magazine subscriptions and place a magazine subscription order.

A further object of the invention is to provide a stored value card wherein, upon receiving the stored value card holder's magazine subscription order, the stored value card issuer processes the magazine subscription order.

A further object of the invention is to provide a stored value card wherein, after processing the magazine subscription order, the stored value card holder receives the magazine selected.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a flow diagram of a method for providing a stored value card that may be redeemed for either cash value or merchandise.

FIG. 2 shows the front surface of a stored value card according to the present invention.

FIG. 3 shows the back surface of a stored value card according to the present invention.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the scope of the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The invention places consideration into the stored value card holder's possession. Since the stored value card can be redeemed for cash at the merchant's place of business, the holder has a purchasing decision. The stored value card holder can redeem the stored value card for the amount of the stored value for goods and/or services from the merchant, or the stored value card holder can redeem the stored value card for the amount of the stored value on the card. The stored value card holder can contact the merchant via a toll-free customer service phone number to request that a check be sent to them for the remaining balance on the stored value card. The stored value card holder can also request a check by completing a form on a specially designed web page with a unique web-site address.

The stored value card of the present invention is similar to ordinary plastic credit cards both in size and composition. The face of the stored value card will also state “This card has cash value”. The back of the card will state the original value of the card along with a unique card number. The back of the card will also state instructions on how to redeem the card for magazine subscriptions and how to redeem the card for cash. The back of the card will also include the merchant's customer service telephone number.

The consumer will follow the instructions written on the back of the stored value card to redeem the card for cash. The consumer may access the stored value card issuer's website by entering the unique web-site address listed on the stored value card into a web browser. Once at the web page, the stored value card holder will follow the instructions provided on the web page. The stored value card holder is instructed to type in their name, address, email address and their unique stored value card number. Once the stored value card holder has entered this information, the stored value card holder must select a “Continue” button on the webpage to submit their request to redeem the stored value card for cash value.

After the stored value card holder has submitted their request to redeem their stored value card for cash value, the stored value card issuer will verify that the stored value card number is a valid number with a remaining open balance on the stored value card. If so, the stored value card issuer will instruct its Accounts Payable department to issue a check to be sent to the stored value card holder within two weeks of the value card holder's request. The value card holder will then be notified that their check will be processed and mailed to them.

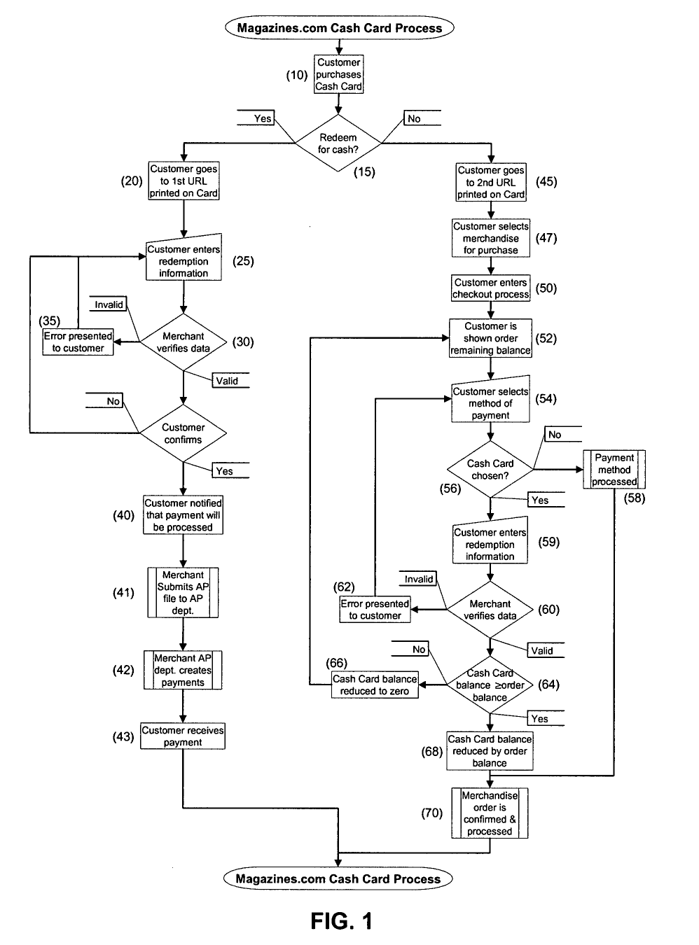

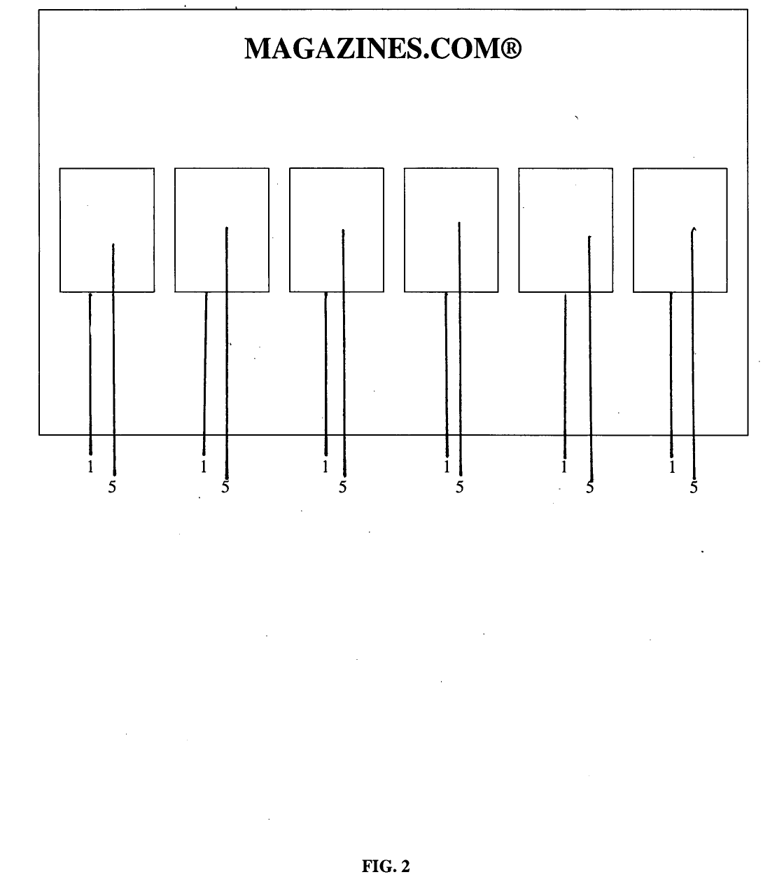

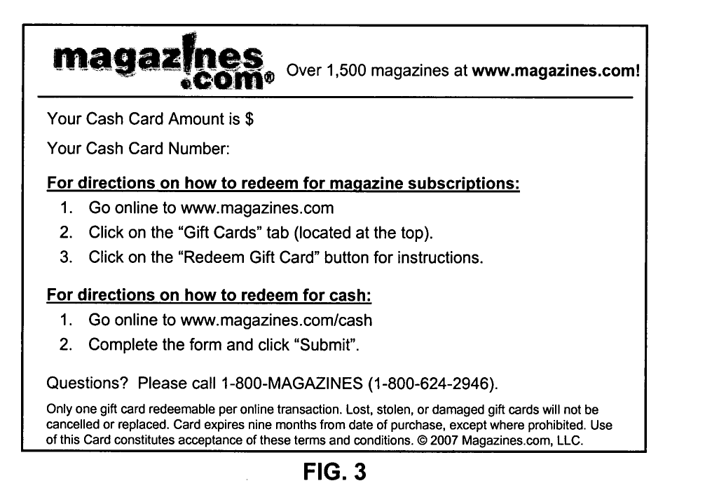

One embodiment of the stored value card system is shown in FIG. 1. In this embodiment, the stored value card process begins with the purchase by a consumer of a stored value card (as shown in FIGS. 2 & 3) at step (10). The consumer may elect to keep the card or to transfer it to another person. The person with possession of the card, whether the original purchaser, the purchaser's transferee, or any subsequent transferee, is the stored value card holder. The stored value card holder may elect to redeem the stored value card for merchandise or for cash value, at step (15). To begin the redemption process, the stored value card holder may follow instructions printed on the back of the stored value card (FIG. 3), wherein the instructions include a toll-free telephone number, and separate internet website addresses (uniform resource locators, or “URLs”), one for cash redemption and one for merchandise. Upon dialing the toll-free telephone number or entering the internet website address for cash redemption into a web browser (20), the stored value card holder is connected to the stored value card issuer and is provided with further instructions. Once connected to the stored value card issuer, the stored value card holder is instructed to provide their redemption information (unique stored value card number and, optionally, their name, mailing address, email address), at step (25). Once the stored value card holder has provided this information (25), the stored value card issuer verifies that the stored value card number is a valid number with a remaining open balance on the stored value card, at step (30). If the stored value card number is not valid, or if no open balance remains on the stored value card, the stored value card holder is notified that the stored value card number is invalid or that no open balance remains, at step (35). If the stored value card number is valid and if an open balance remains on the stored value card, then the stored value card holder is asked to confirm that they wish to continue to submit a request to redeem their stored value card, at step (36). If, at step (36), the stored value card holder does not provide such confirmation, they are again asked instructed to provide their redemption information (unique stored value card number and, optionally, their name, mailing address, email address), at step (25). After confirmation at step (36), the stored value card holder is notified that payment will be processed, at step (40). At step (41), the stored value card issuer initiates issuance of a check to be sent to the stored value card holder by, for example, submitting an accounts payable file to an accounts payable department. Payment is issued (42) and the stored value card holder is paid (43).

If the stored value card holder elects to redeem the stored value card for merchandise (i.e., declines to redeem the card for cash), at step (15), then the stored value card holder dials the toll-free telephone number or enters the internet website address for magazine subscription redemption into a web browser (45), thus connecting the stored value card holder to the stored value card issuer and providing the stored value card holder with further instructions. At step (47) the stored value card holder selects merchandise (magazine subscriptions) to purchase. After completing the merchandise selection process (47), the stored value card holder enters the checkout process at step (50). The balance owed, calculated from the merchandise selected at (47), is displayed to the stored value card holder at (52). The stored value card holder is then prompted, at (54), to select a method of payment for the merchandise selected at (47). If the stored value card holder elects, at (56), not to use a stored value card for payment, the stored value card holder is provided with alternative payment options (e.g., payment via credit card, wire transfer, etc.) and such alternative payment method is processed (58). The corresponding merchandise order is then confirmed and processed, at (70). If, at (56), the stored value card holder elects to use a stored value card for payment, the stored value card holder is instructed to provide their redemption information (unique stored value card number and, optionally, their name, mailing address, email address), at step (59). Once the stored value card holder has provided this information (59), the stored value card issuer verifies that the stored value card number is a valid number with a remaining open balance on the stored value card, at step (60). If the stored value card number is not valid, or if no open balance remains on the stored value card, the stored value card holder is notified that the stored value card number is invalid or that no open balance remains, at step (62), and the stored value card holder is prompted again to select a method of payment (54). If the stored value card number is valid and if an open balance remains on the stored value card, then the stored value card balance is compared with the merchandise order balance (64). If the stored value card balance is less than the order balance, then the stored value card balance is reduced to zero (66), the customer is shown the remaining order balance (52) and is prompted again to select a method of payment (54). If the stored value card balance is greater than or equal to the order balance, then the order balance is subtracted from the stored value card balance (68) and the merchandise order is confirmed and processed (70). As shown in FIG. 2, there are cards, such as cash cards (1), which may have one or more designs on their surface (5).

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

1. A method of using a stored value card comprising:
presenting a purchaser with an opportunity to buy said stored value card;
receiving payment from said purchaser to pay for said stored value card, wherein said payment is in any denomination having a first monetary value;
creating a stored value card account for a purchased stored value card;
receiving purchaser data from said purchaser, wherein said purchaser data comprises at least one entry selected from a group comprising name, hobby, mailing address, field of employment, and email address;
issuing said stored value card to said purchaser, wherein said purchaser is regarded as a stored value card holder, wherein said purchaser can elect to retain said stored value card or to transfer said stored value card to a recipient, wherein said recipient in possession of said stored value card is deemed said stored value card holder, wherein said stored value card holder receives a plurality of rights of said purchaser as to said stored value card;
redeeming said stored value card for a second monetary value or for merchandise at the selection of said stored value card holder.

2. The method according to claim 1, further comprising:
receiving a selection to redeem the stored value card for monetary value;
verifying a data on said stored value card;
notifying said stored value card holder that said second monetary value will be provided; and
providing the stored value card holder with said second monetary value.

3. The method according to claim 1, further comprising:
receiving a selection to redeem said stored value card for merchandise;
verifying said stored value card data;
processing said selection to redeem said stored value card for merchandise; and
providing said merchandise to said stored value card holder.

4. The method according to claim 1, wherein said purchaser data is used as a marketing tool.
